(19) United States
(12) Patent Application Publication
(10) Pub. No.: US 2011/0280381 A1
(43) Pub. Date: Nov. 17, 2011

(54) RECEIVING APPARATUS, ANNOUNCEMENT CONTROL METHOD, AND PROGRAM

(75) Inventors: Takuya OKAMOTO, Chiba (JP); Satoshi Okada, Tokyo (JP); Ryuichiro Shimura, Kanagawa (JP); Hiroo Takahashi, Tokyo (JP); Tamotsu Ikeda, Tokyo (JP)

(73) Assignee: Sony Corporation, Tokyo (JP)

(21) Appl. No.: 13/100,379

(22) Filed: May 4, 2011

(30) Foreign Application Priority Data
May 12, 2010 (JP) 2010-110418

(51) Int. Cl. H04M 11/04; G06F 19/00

(52) U.S. Cl. 379/37; 702/15

(57) ABSTRACT

Disclosed herein is a receiving apparatus including: a receiving portion configured to receive warning information; a setting portion configured to establish settings regarding an announcing action to be performed upon receipt of the warning information, in accordance with operations performed by a user; and a control portion configured to control, upon receipt of the warning information, the announcing action in accordance with the settings established by the setting portion.

### BACKGROUND OF THE INVENTION

1. Field of the Invention

The present invention relates to a receiving apparatus, an announcement control method, and a program. More particularly, the invention relates to a receiving apparatus, an announcement control method, and a program for establishing the settings of the announcing action to be performed upon receipt of warning information such as earthquake motion warning information.

2. Description of the Related Art

OFDM (Orthogonal Frequency Division Multiplexing) scheme has been proposed as a terrestrial digital broadcast modulation method used to modulate each of a large number of orthogonal carriers through PSK (Phase Shift Keying) or QAM (Quadrature Amplitude Modulation).

The OFDM scheme involves dividing an entire transmission band using numerous subcarriers. It follows that despite its narrow bandwidth per subcarrier at a low transmission speed, the scheme is characterized by the overall transmission speed of the scheme is substantially the same as those of ordinary modulation methods.

Further, in the OFDM scheme, because numerous subcarriers are transmitted in parallel, symbol speed is slowed down. This makes it possible to shorten the relative time lengths of multiple paths with regard to the time length per symbol. Therefore, the OFDM scheme is highly resistant to multi-path interference.

Furthermore, with data assigned to a plurality of subcarriers, the OFDM scheme also has by the ability to constitute a transmitter circuit using an IFFT (Inverse Fast Fourier Transform) arithmetic circuit that performs inverse Fourier transform upon modulation and a receiver circuit employing an FFT (Fast Fourier Transform) arithmetic circuit that carries out Fourier transform upon demodulation.

Given the above advantages, the OFDM scheme is mainly applied to terrestrial digital broadcasts that are highly vulnerable to multi-path interference. One typical terrestrial digital broadcast standard adopting the OFDM scheme is ISDB-T (Integrated Services Digital Broadcast-Terrestrial).

The ISDB-T standard stipulates that an AC (auxiliary channel) signal of 204-bit information per unit be transmitted using a predetermined subcarrier in an OFDM symbol so as to transmit additional information about transmission control over modulation waves or earthquake motion warning information. The AC signal constitutes an additional information signal regarding the broadcasts.

The AC signal is subjected to differential BPSK (Binary Phase Shift Keying) modulation. Differential BPSK modulation is a modulation method used to differential-encode data streams to be transmitted and to convert the differential-encoded information (0, 1) into a complex signal (I-signal and Q-signal) having constellation points of (+4/3, 0) and (−4/3, 0) respectively.

FIG. 1 is a schematic view showing an AC (auxiliary channel) signal.

In FIG. 1, the numeral given under each item of information represents the ordinal position of the bit in question in the information. It should be noted that the horizontal length of each item of information is not proportional to the number of bits.

As shown in the upper part of FIG. 1, an AC signal of 204-bit information per unit is formed starting with a one-bit differential modulation reference signal followed by three-bit structure identification and 200-bit additional information about transmission control over modulation waves or earthquake motion warning information, in that order.

The reference signal is a signal that provides the amplitude and phase of reference for differential demodulation.

The structure identification constitutes a signal that identifies the structure of the AC signal. In the structure identification, a numeral 000, 010, 011, 100, 101, or 111 indicates that additional information about transmission control over modulation waves is transmitted; and a numeral 001 or 110 indicates that earthquake motion warning information is transmitted. If the structure identification has the numeral 001 or 110, the 200 bits that follow it carry the earthquake motion warning information.

The earthquake motion warning information is transmitted on an AC carrier in segment No. 0. The entire frequency band for use by digital broadcasts under the ISDB-T standard is divided into 13 segments numbered 0 through 12. A carrier (AC carrier) that transmits the AC signal is stipulated for each of the segments.

The 200-bit earthquake motion warning information is made up of a 13-bit synchronous signal, a 2-bit start/end flag, a 2-bit update flag, 3-bit signal identification, 88-bit earthquake motion warning detailed information, a 10-bit CRC (Cyclic Redundancy Check), and 82 parity bits.

The synchronous signal constitutes information that points to the beginning of earthquake motion warning information. Specifically, if the structure identification is 001, WO=“1010111101110” is inserted alternately in units of a frame; if the structure identification is 110, then W1=“0101000010001” (i.e., inverted word of WO) is inserted alternately in units of a frame.

The start/end flag is 00 if there is earthquake motion warning information, and is 11 if there is no earthquake motion warning information.

The update flag is incremented by one every time any change occurs in a series of earthquake motion warning detailed information transmitted when the start/end flag is 00. The flag, when thus updated, notifies the receiving apparatus that the signal identification and/or earthquake motion warning information has been updated.

The signal identification constitutes a signal used to identify the earthquake motion warning detailed information that follows the signal.

In the signal identification, a numeral 000 indicates that there is a locality or localities targeted by the earthquake motion warning detailed information, and a numeral 001 indicates that there is no locality targeted by the earthquake motion warning detailed information. That there is a locality or localities targeted by the earthquake motion warning detailed information signifies that within the broadcast area of interest, there exists a locality or localities targeted by the earthquake motion warning detailed information. That there is no locality targeted by the earthquake motion warning detailed information signifies that within the broadcast area, there exists no locality targeted by the earthquake motion warning detailed information.

Also in the signal identification, a numeral 010 indicates that there is a locality or localities targeted by a test signal of earthquake motion warning detailed information, and a numeral 011 indicates that there is no locality targeted by the test signal of earthquake motion warning detailed information. A numeral 111 indicates that there is no earthquake motion warning detailed information (broadcast operator identification). A numeral 100, 101 or 110 in the signal identification has yet to be defined.

When the signal identification is any one of 000, 001, 010 and 011, earthquake motion warning detailed information is transmitted, composed of information about the current time of day at which earthquake motion warning information is issued, information indicative of the localities targeted by the earthquake motion warning, and information about the epicenter related to the earthquake motion warning.

When the signal identification is 111, the broadcast operator identification is transmitted as the earthquake motion warning detailed information. When the signal identification is 100, 101, or 110, ALL1 is transmitted as the earthquake motion warning detailed information.

The CRC is a CRC code generated by use of a generating polynomial with regard to bits 22 through 112 relative to the beginning of the AC signal.

The parity bits constitute an error-correcting code generated by use of a compacted code (187, 107) of a difference set cyclic code (273, 191) with regard to bits 18 through 122 relative to the beginning of the AC signal. In connection with the present invention, a reference should be made to a non-patent document titled “STD-B31,” reached at “http://www.arib.or.jp/english/html/overview/doc/2-STD-B31v1-8.pdf.”

### SUMMARY OF THE INVENTION

Under the ISDB-T standard, as described above, earthquake motion warning information is transmitted so as to give an early notification of the occurrence of an earthquake. However, the standard has no provisions for how to perform an announcing action once the earthquake motion warning information is received.

If the receiving apparatus that receives the earthquake motion warning information is devised to carry out a suitable announcing action, the user of the apparatus will be given a beneficial service thereby.

For example, if an earthquake is announced to have occurred not only in the locality where the user resides but also in some remote locality where the user's relatives live, the user can take quick measures to check their safety, which is a convenient feature. Although it may not be necessary immediately to know the occurrence of an earthquake in remote locations, the user can remain unaware of the disaster for hours until a TV news program is received or an Internet news site is checked.

If the epicenter is far away and if the degree of danger of the earthquake is known before the earthquake motion reaches the user's locality, then the user can take shelter depending on the degree of the detected danger or take other safety measures, which is also convenient. It is also convenient if the time it takes for the earthquake to reach the area is accurately known beforehand.

The present invention has been made in view of the above circumstances and provides innovative arrangements for establishing settings with regard to the announcing action to be performed upon receipt of warning information such as earthquake motion warning information.

In carrying out the present invention and according to one embodiment thereof, there is provided a receiving apparatus including: receiving means for receiving warning information; setting means for establishing settings regarding an announcing action to be performed upon receipt of the warning information, in accordance with operations performed by a user; and control means for controlling, upon receipt of the warning information, the announcing action in accordance with the settings established by the setting means.

Preferably, the setting means may establish whether or not to perform the announcing action.

Preferably, the setting means may establish at least one of two settings, one of the two settings specifying that the content of a warning is to be announced by screen display, the other setting specifying that the content of the warning is to be announced by audio output.

Preferably, the setting means may establish a receiving channel from among the channels on which programs are being broadcast; and upon receipt of the warning where the setting is established specifying that the content of the warning is to be announced by screen display, the control means may display information indicative of the content of the warning on a screen together with an image of the program being broadcast on the receiving channel.

Preferably, the setting means may establish a receiving channel from among the channels on which programs are being broadcast; and upon receipt of the warning where the setting is established specifying that the content of the warning is to be announced by audio output, the control means may provide an audio output indicative of the content of the warning together with an image of the program being broadcast on the receiving channel and displayed on a screen.

Preferably, the receiving apparatus of the embodiment of the present invention may further include generating means for generating vibration; wherein the setting means may establish whether or not to perform the announcing action so as to announce the occurrence of an earthquake using the vibration generated by the generating means.

Preferably, the setting means may establish a locality; and if the warning information is received and if the localities included in the warning information and represented by targeted locality information indicative of the localities targeted by the warning include the locality established by the setting means, then the control means may perform the announcing action in accordance with the settings established by the setting means.

Preferably, the setting means may establish a plurality of localities and establish the settings regarding the announcing action for each of the plurality of localities; and the control means may perform the announcing action in accordance with the settings established for each of the plurality of localities.

Preferably, the warning information may be earthquake motion warning information.

Preferably, the setting means may establish the location of the receiving apparatus; and if the warning information constituting the earthquake motion warning information is received, then the control means may, based on the location of an epicenter represented by information included in the warning information, calculate the time for an earthquake motion to reach the location established by the setting means and control the announcing action in accordance with the calculated time.

Preferably, the receiving apparatus of the present invention may further include measuring means for measuring a current location; wherein, if the warning information constituting the earthquake motion warning information is received, then the control means may, based on the location of an epicenter represented by information included in the warning information, calculate the time for an earthquake motion to reach the location measured by the measuring means and control the announcing action in accordance with the calculated time.

Preferably, the setting means may establish a seismic intensity serving as a reference by which to determine whether or not to perform the announcing action; and if the warning information constituting the earthquake motion warning information is received and if the seismic intensity represented by information included in the warning information exceeds the seismic intensity established by the setting means, then the control means may perform the announcing action.

Preferably, if the warning information is received and if the user, prompted to select whether or not to establish a seismic intensity, selects establishment of the seismic intensity, then the setting means may establish the seismic intensity represented by the information included in the warning information as the seismic intensity serving as the reference by which to determine whether or not to perform the announcing action.

Preferably, the receiving apparatus of the embodiment of the present invention may further include measuring means for measuring a seismic intensity; wherein the setting means may establish a seismic intensity serving as a reference by which to determine whether or not to perform the announcing action; and wherein, if the seismic intensity measured by the measuring means exceeds the seismic intensity established by the setting means, then the control means may perform the announcing action.

Preferably, if the warning information constituting the earthquake motion warning information is received and if the seismic intensity measured by the measuring means exceeds the seismic intensity established by the setting means, then the control means may perform the announcing action.

Preferably, the receiving apparatus of the embodiment of the present invention may further include signal receiving means for receiving a signal output from a measuring device measuring a seismic intensity; wherein the setting means may establish a seismic intensity serving as a reference by which to determine whether or not to perform the announcing action; and, if the seismic intensity represented by the signal received by the signal receiving means exceeds the seismic intensity established by the setting means, then the control means may perform the announcing action.

According to another embodiment of the present invention, there is provided an announcement control method including the steps of: receiving warning information; establishing settings regarding an announcing action to be performed upon receipt of the warning information, in accordance with operations performed by a user; and controlling, upon receipt of the warning information, the announcing action in accordance with the settings.

According to a further embodiment of the present invention, there is provided a program for causing a computer to execute a procedure including the steps of: receiving warning information; establishing settings regarding an announcing action to be performed upon receipt of the warning information, in accordance with operations performed by a user; and controlling, upon receipt of the warning information, the announcing action in accordance with the settings.

According to the present invention embodied as outlined above, warning information is first received. In accordance with the operations performed by the user, settings are established regarding the announcing action to be carried out upon receipt of the warning information. Also, the announcing action is controlled in accordance with the settings upon receipt of the warning information.

Thus according to the present invention, it is possible to establish suitable settings with regard to the announcing action to be performed upon receipt of the warning information such as earthquake motion warning information.

### BRIEF DESCRIPTION OF THE DRAWINGS

Further features and advantages of the present invention will become apparent upon a reading of the following description and appended drawings in which:

FIG. 1 is a schematic view showing an AC signal;

FIG. 2 is a block diagram showing a typical structure of a receiving apparatus embodying the present invention;

FIG. 3 is a block diagram showing a typical structure of a receiving block included in FIG. 2;

FIG. 4 is a block diagram showing a typical structure of an earthquake motion warning information decoding circuit included in FIG. 3;

FIG. 5 is a block diagram showing a typical functional structure of a controller;

FIG. 6 is a flowchart explanatory of a setting process performed by the receiving apparatus;

FIG. 7 is a schematic view showing typical settings regarding an announcing action;

FIG. 8 is a flowchart explanatory of another setting process performed by the receiving apparatus;

FIG. 9 is a flowchart explanatory of an announcing process performed by the receiving apparatus;

FIG. 10 is a flowchart explanatory of another announcing process performed by the receiving apparatus;

FIG. 11 is a flowchart explanatory of another announcing process performed by the receiving apparatus;

FIG. 12 is a schematic view showing typical images that vary with the time it takes for an earthquake to arrive;

FIG. 13 is a flowchart explanatory of another announcing process performed by the receiving apparatus;

FIG. 14 is a flowchart explanatory of further announcing process performed by the receiving apparatus;

FIG. 15 is a block diagram showing a typical configuration of a receiving system as a first embodiment of the invention;

FIG. 16 is a block diagram showing a typical configuration of the receiving system as a second embodiment of the invention;

FIG. 17 is a block diagram showing a typical configuration of the receiving system as a third embodiment of the invention; and

FIG. 18 is a block diagram showing a typical structure of a computer.

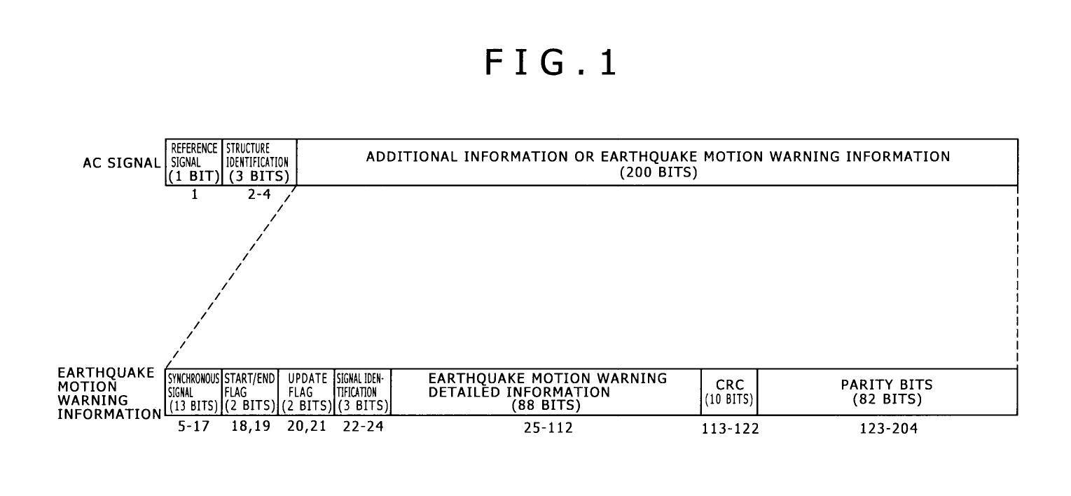

### DETAILED DESCRIPTION OF THE PREFERRED EMBODIMENTS

[Structure of the Receiving Apparatus]

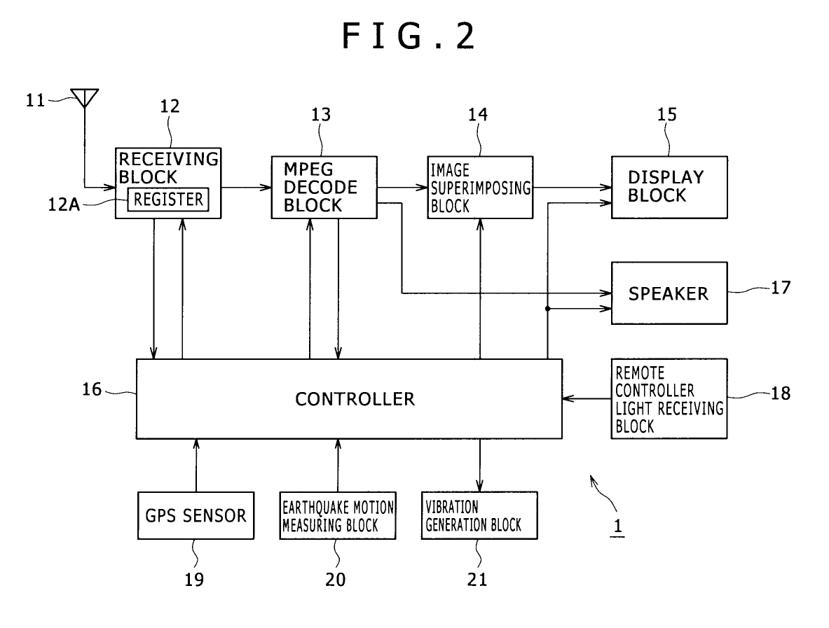

FIG. 2 is a block diagram showing a typical structure of a receiving apparatus 1 embodying the present invention.

The receiving apparatus 1 is an apparatus capable of receiving digital broadcasts such as those in compliance with the ISDB-T standard. Typical receiving apparatuses include stay-at-home TV sets and portable devices compatible with one-segment digital broadcasts. Broadcast waves received from broadcasting stations are received by an antenna 11 and the received signals from there are forwarded to a receiving block 12.

The receiving block 12 selects a desired transmission channel and performs a demodulating process on the channel to extract a digital signal in 0's and 1's. Also, the receiving block 12 performs error correction on the demodulated information to acquire TS packets sent from the broadcasting station. The TS packets contain data such as pictures and sounds. The TS packets carrying the video and audio data are fed to an MPEG decode block 13.

Furthermore, when earthquake motion warning information is transmitted by an AC signal, the receiving block 12 decodes the received earthquake motion warning information and outputs the decoded information to a controller 16. For example, the supply of earthquake motion warning information is accomplished by the controller 16 reading the earthquake motion warning information from a register 12A where the information has been written inside the receiving block 12.

The MPEG decode block 13 extracts video data and audio data by decoding the TS packets fed from the receiving block 12. The MPEG decode block 13 proceeds to output the video data to an image superimposing block 14 and the audio data to an audio processing circuit, not shown. The audio processing circuit performs predetermined processing on the audio data and causes speakers 17 to output the resulting sounds in keeping with image display.

The image superimposing block 14 superimposes the image whose data is fed from the MPEG decode block 13 on the information supplied from the controller 16, and outputs to a display block 15 the image data overlaid with earthquake-related information. If earthquake-related information is not supplied from the controller 16, the image superimposing block 14 outputs the image data fed from the MPEG decode block 13 to the display block 15 as it is.

The display block 15 is a display device such as an LCD (liquid crystal display) or a PDP (plasma display panel). Based on the data fed from the image superimposing block 14, the display block 15 displays various images including those overlaid with the earthquake-related information.

The controller 16 controls the overall performance of the receiving apparatus 1 based on the information supplied from a remote controller light receiving block 18.

For example, upon reading earthquake motion warning information from the register 12A of the receiving block 12, the controller 16 outputs the earthquake-related information to the image superimposing block 14 in accordance with the content of the earthquake motion warning information so that the information may be displayed superimposed on the image. Also, if the earthquake-related information is to be announced to the user not by screen display but by audio output, the controller 16 outputs to the speakers 17 audio data arranged to inform the user of the earthquake-related information so that a warning sound or voice may be output.

Furthermore, before announcing the earthquake-related information to the user (i.e., in an announcing action), the controller 16 establishes settings about the announcing action based on the operations carried out by the users. The announcing action is performed upon receipt of the earthquake motion warning information in accordance with the settings established by the user beforehand. Detailed settings regarding the announcing action will be discussed later.

The speakers 17 output a voice or siren sound to inform the user of earthquake-related information on the basis of the data supplied from the controller 16.

The remote controller light receiving block 18 receives a signal transmitted from a remote controller and outputs to the controller 16 information indicative of the specifics of the user's operations. The settings regarding the announcing action may be established using the remote controller, for example.

A GPS (global positioning system) sensor 19 measures the current location and outputs to the controller 16 position information indicative of the current location.

An earthquake motion measuring block 20 measures as an earthquake motion the tremor generated at the location where the receiving apparatus 1 is set up. The earthquake motion measuring block 20 proceeds to output to the controller 16 seismic intensity information representative of the intensity of the measured earthquake motion. For example, the seismic intensity represented by the seismic intensity information output from the earthquake motion measuring block 20 may be the same as one of the levels of seismic intensity stipulated by the Japan Meteorological Agency.

The earthquake motion measuring block 20 may operate in one of two modes for example. In one mode, the earthquake motion measuring block 20 may be an earthquake motion sensor that measures seismic intensity where it is set up. In another mode, the earthquake motion measuring block 20 may receive signals from an earthquake motion sensor set up in the building where the receiving apparatus 1 is installed and measure seismic intensity using the received signals. In the first case above, the earthquake motion measuring block 20 functions as a measuring portion configured to measure seismic intensity. In the second case, the earthquake motion measuring block 20 functions as a signal receiving portion configured to receive signals from an external sensor and measure seismic intensity based on the received signals.

A vibration generating block 21 generates vibration under control of the controller 16. The vibration generating block 21 is incorporated in the receiving apparatus 1 if the latter is a portable device compatible with one-segment digital broadcasts for example.

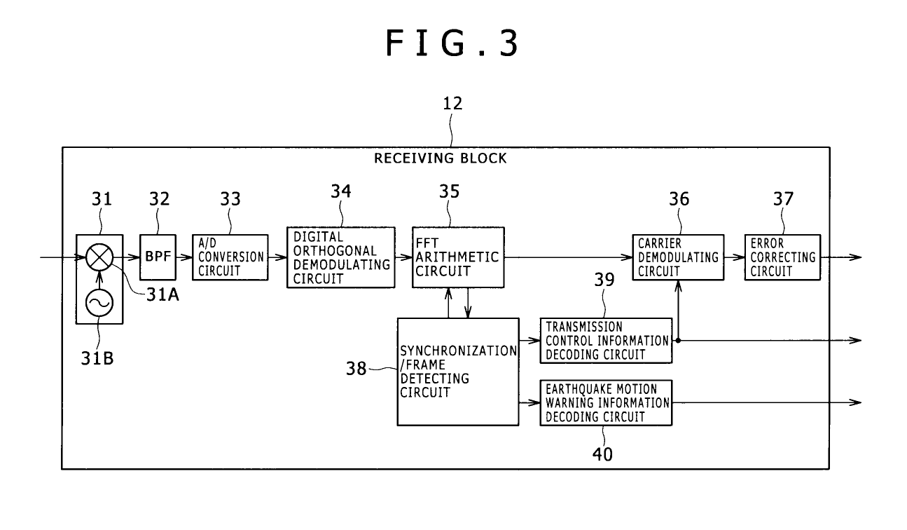

FIG. 3 is a block diagram showing a typical structure of the receiving block 12 included in FIG. 2.

The receiving block 12 is made up of a tuner 31, a BPF (band-pass filter) 32, an A/D conversion circuit 33, a digital orthogonal demodulating circuit 34, an FFT arithmetic circuit 35, a carrier demodulating circuit 36, an error correcting circuit 37, a synchronization/frame detecting circuit 38, a transmission control information decoding circuit 39, and an earthquake motion warning information decoding circuit 40. The received signal coming from the antenna 11 as an OFDM signal is forwarded to the tuner 31.

The tuner 31 is composed of a multiplying circuit 31A and a local oscillator 31B. The tuner 31 performs frequency conversion on an RF (Radio Frequency) signal coming from the antenna 11 so as to generate an IF signal. The generated IF (Intermediate Frequency) signal is sent to the BPS 32.

The BPF 32 performs filtering on the IF signal and outputs the filtered signal to the A/D conversion circuit 33.

The A/D conversion circuit 33 performs A/D conversion on the IF signal to digitize it, and outputs the digitized IF signal to the digital orthogonal demodulating circuit 34.

The digital orthogonal demodulating circuit 34 orthogonally demodulates the digitized IF signal into a baseband OFDM signal using a carrier signal of a predetermined frequency (i.e., carrier frequency). The digital orthogonal demodulating circuit 34 proceeds to output the baseband OFDM signal to the FFT arithmetic circuit 35. The baseband signal output from the digital orthogonal demodulating circuit 34 is a complex signal containing real and imaginary components having undergone the orthogonal demodulation.

The FFT arithmetic circuit 35 extracts a signal of an effective symbol length from one OFDM symbol signal and performs FFT arithmetic operations on the extracted signal. That is, the FFT arithmetic circuit 35 performs FFT on the signal left out following the removal of the signal of a guard interval length from one OFDM symbol signal.

The signal extracted by the FFT arithmetic circuit 35 performing FFT and modulated into subcarriers is a complex signal composed of real and imaginary components. The signal extracted by the FFT arithmetic circuit 35 is supplied to the carrier demodulating circuit 36 and synchronization/frame detecting circuit 38.

The carrier demodulating circuit 36 performs carrier demodulation on the signals demodulated from the subcarriers. Specifically, the carrier demodulating circuit 36 performs a differential demodulation process on a differentially modulated signal (DQPSK signal) and an equalization process on synchronously modulated signals (QPSK, 16QAM, and 64QAM signals). The signals obtained from these processes are output to the error correcting circuit 37.

The error correcting circuit 37 performs de-interleave processing on the signals that were interleaved by the transmitting side. The processing includes de-puncture, Viterbi decoding, diffusion signal removal, and RS decoding. Following the de-interleave processing, the error correcting circuit 37 outputs decoded data. The decoded data output from the error correcting circuit 37 is sent to the MPEG decode block 13.

The synchronization/frame detecting circuit 38 performs various synchronizing processes based on the baseband OFDM signal fed from the digital orthogonal demodulating circuit 34 to the FFT arithmetic circuit 35 and on the signals demodulated by the FFT arithmetic circuit 35 from the subcarriers. For example, the synchronization/frame detecting circuit 38 detects the boundaries of OFDM symbols through a synchronizing process and outputs information specifying the range of FFT's and their timings to the FFT arithmetic circuit 35.

Also, the synchronization/frame detecting circuit 38 extracts a TMCC (Transmission and Multiplexing Configuration and Control) signal constituting transmission control information from a predetermined subcarrier of a signal demodulated by the FFT arithmetic circuit 35, and detects the synchronous signal of the TMCC signal to detect the boundary of an OFDM frame. The synchronization/frame detecting circuit 38 outputs a frame synchronous signal indicative of the boundary position of the detected OFDM frame to the transmission control information decoding circuit 39 together with the TMCC signal.

The synchronization/frame detecting circuit 38 extracts an AC signal from a predetermined subcarrier of a signal demodulated by the FFT arithmetic circuit 35, and detects the synchronous signal of the AC signal to detect the boundary of the OFDM frame. The synchronization/frame detecting circuit 38 outputs a frame synchronous signal indicative of the boundary position of the detected OFDM frame to the earthquake motion warning information decoding circuit 40 together with the AC signal.

Using a difference set cyclic code, the transmission control information decoding circuit 39 performs error correction on the TMCC information included in the TMCC signal of which the synchronization has been assured. Also, the transmission control information decoding circuit 39 outputs the TMCC information having undergone error correction to the carrier demodulating circuit 36 so as to control the processing of the carrier demodulating circuit 36.

Using the difference set cyclic code, the earthquake motion warning information decoding circuit 40 performs error correction on the earthquake motion warning information included in the AC signal of which the synchronization has been assured. The earthquake motion warning information decoding circuit 40 also carries out CRC using the CRC code. The earthquake motion warning information decoding circuit 40 proceeds to output the earthquake motion warning information having undergone error correction and CRC. The earthquake motion warning information thus output is written to the register 12A shown in FIG. 2.

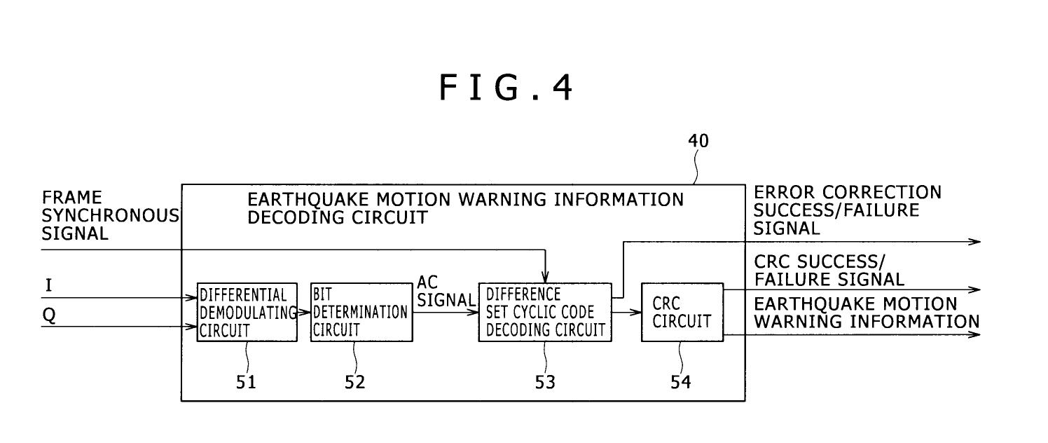

FIG. 4 is a block diagram showing a typical structure of the earthquake motion warning information decoding circuit 40 included in FIG. 3.

The earthquake motion warning information decoding circuit 40 is made up of a differential demodulating circuit 51, a bit determination circuit 52, a difference set cyclic code decoding circuit 53, and a CRC circuit 54.

The differential demodulating circuit 51 differentially demodulates the AC signal that has been input as a complex signal in order to generate a complex signal of constellation points corresponding to the original information bit. The signal differentially demodulated by the differential demodulating circuit 51 is supplied to the bit determination circuit 52.

The bit determination circuit 52 performs bit determination based on the differentially demodulated signal. That is, from the constellation points on the IQ plane of the differentially demodulated signal, the bit determination circuit 52 determines whether the modulated value is “0” or “1” and outputs one of the two bit values. The bit determination circuit 52 thus outputs the AC signal in bit streams. The AC signal output from the bit determination circuit 52 is sent to the difference set cyclic code decoding circuit 53.

The difference set cyclic code decoding circuit 53 detects the frame head of the AC signal based on the frame synchronous signal supplied from the synchronization/frame detecting circuit 38. After receiving bits up to bit 204 that is the last of the bits making up the AC signal, the difference set cyclic code decoding circuit 53 performs error correction by use of the difference set cyclic code included as 82 parity bits in the earthquake motion warning information. The difference set cyclic code decoding circuit 53 proceeds to output the earthquake motion warning information having undergone error correction to the CRC circuit 54.

The difference set cyclic code decoding circuit 53 also outputs an error correction success/failure signal indicating whether error correction has been a success or a failure. The error correction success/failure signal indicates “OK” if the error correction has been a success and “NG” if the error correction has been a failure.

The CRC circuit 54 performs CRC using a 10-bit CRC code included in the earthquake motion warning information, thereby outputting a CRC success/failure signal indicating whether CRC has been a success or a failure together with the earthquake motion warning information. The CRC success/failure signal indicates “OK” if the CRC has been a success and “NG” if the CRC has been a failure.

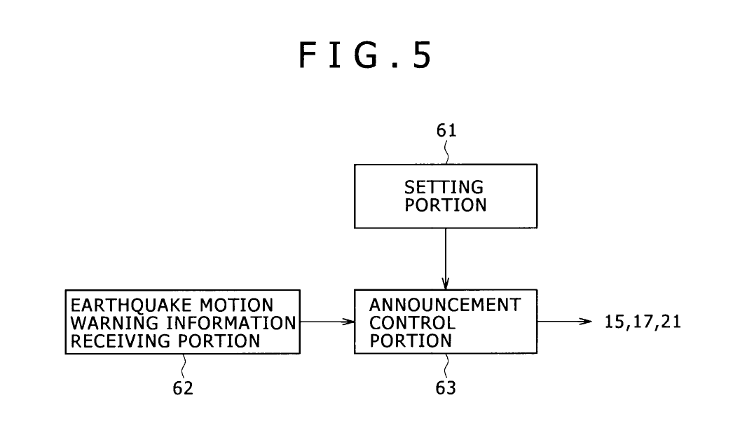

FIG. 5 is a block diagram showing a typical functional structure of the controller 16.

As shown in FIG. 5, the controller 16 implements a setting portion 61, an earthquake motion warning information receiving portion 62, and an announcement control portion 63. At least one of the portions shown in FIG. 5 is implemented by the controller 16 executing an appropriate program or programs.

The setting portion 61 establishes settings regarding an announcing action based on the signal fed from the remote controller light receiving block 18. The setting portion 61 has an internal memory that stores setting information representative of the content of the settings regarding the announcing action. The setting information stored in the memory of the setting portion 61 is retrieved by the announcement control portion 63.

The earthquake motion warning information receiving portion 62 polls (i.e., reads and receives) the information held in the register 12A of the receiving block 12 at predetermined intervals. The earthquake motion warning information receiving portion 62 reads the earthquake motion warning information from the register 12A and outputs the retrieved information to the announcement control portion 63.

When supplied with the earthquake motion warning information from the earthquake motion warning information receiving portion 62, the announcement control portion 63 controls the announcing action in accordance with the content of the settings represented by the setting information stored in the setting portion 61.

[Settings of the Announcing Action]

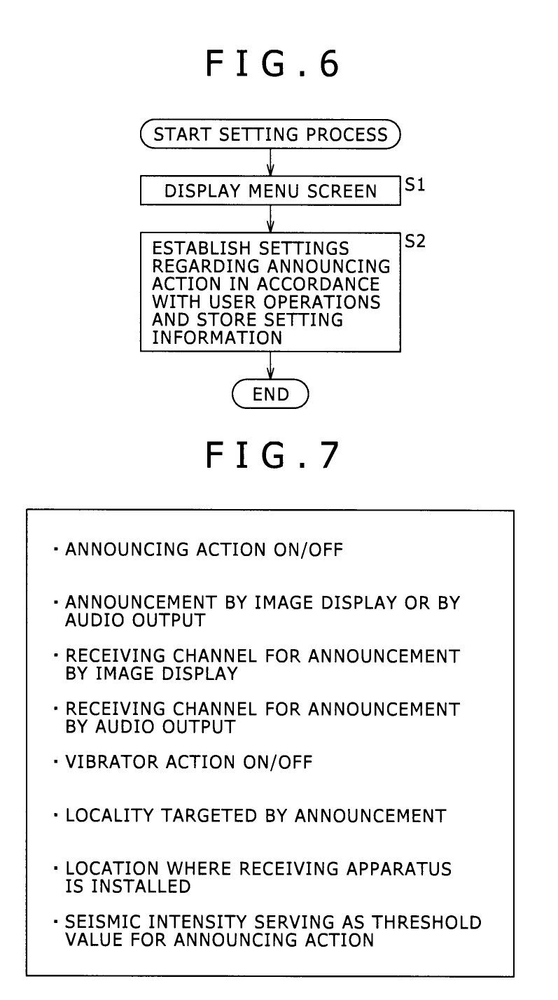

Explained below in reference to the flowchart of FIG. 6 is a setting process performed by the receiving apparatus 1 establishing the settings regarding the announcing action.

This process is started when the user specifies that settings regarding an announcing action are to be established. The settings with regard to the announcing action may be established together with the settings of channels when, say, the receiving apparatus 1 is started for the first time.

In step S1, the setting portion 61 causes the display block 15 to display a menu screen used to establish settings regarding an announcing action. The user makes various settings by operating the remote controller while watching the menu screen on the display block 15.

In step S2, the setting portion 61 receives signals fed from the remote controller light receiving block 18, establishes the settings regarding the announcing action in accordance with the user's operations, and stores the setting information. The setting process is terminated when an end of the process is designated.

FIG. 7 is a schematic view showing typical settings regarding the announcing action.

As shown in FIG. 7, the first setting item permits specifying whether to turn on or off the announcing action. If the announcing action is set to be turned on, the announcing action is performed upon receipt of earthquake motion warning information; if the announcing action is set to be turned off, the announcing action is not carried out even if earthquake motion warning information is received.

The second setting item permits specifying whether earthquake-related information is to be announced by screen display or by audio output. It is also possible to arrange the setting so that the announcement can be made both by screen display and by audio output. If earthquake-related information is set to be announced by screen display, the announcement control portion 63, based on earthquake motion warning information, causes the display block 15 to display text and images indicating the time of day at which an earthquake occurred (i.e., time of day represented by current time information and at which the earthquake motion warning information is output), the location of the epicenter, and the localities affected by the earthquake, among others. For example, a map image may be displayed and the epicenter and the affected localities may be indicated on the map.

On the other hand, if earthquake-related information is set to be announced by audio output, the announcement control portion 63, based on the earthquake motion warning information, causes the speakers 17 to output a voice and a siren sound indicating the time of day at which the earthquake occurred, the location of the epicenter, and the localities affected by the earthquake.

The type of the siren sound may be set as desired. The types or the siren may include one in which the siren is output at constant intervals, one in which the siren is output at progressively shortened intervals as the earthquake approaches, and one in which the frequency of the siren is progressively raised as the earthquake approaches. As another alternative, a sound similar to the ring tone of a mobile phone may be output as the siren sound.

The third setting item permits specifying the receiving channel on which earthquake-related information is to be announced by screen display. The receiving channel is selected from among the channels on which TV programs are being broadcast. If earthquake-related information is set to be announced by screen display and if earthquake motion warning information is received, the announcement control portion 63 starts receiving the channel set in this item and causes the display block 15 to display text and images giving the earthquake-related information along with the image of the TV program being broadcast.

The fourth setting item permits specifying the receiving channel on which earthquake-related information is to be announced by audio output. If earthquake-related information is set to be announced by audio output and if earthquake motion warning information is received, the announcement control portion 63 causes the speakers 17 to output a voice and a siren sound announcing the above-mentioned earthquake-related information. Also, the announcement control portion 63 starts receiving the previously set channel and causes the display block 15 to display the image of the TV program being broadcast on that channel.

Whereas there is no need to receive any TV program to get the announcement of earthquake-related information, the occurrence of an earthquake generally prompts broadcasting stations to broadcast news about the current damage situation in the ongoing TV programs. When the reception of a TV program is automatically started, the user can check information about the earthquake during the program without performing any operation to start receiving the program. It is also possible to make settings so that the reception of a TV program is automatically started and turned off upon elapse of a predetermined time period following the receipt of earthquake motion warning information.

The fifth setting item permits specifying whether to turn on or off a vibrator action. This setting may be provided typically where the receiving apparatus 1 is a portable device. If the vibrator action is set to be on, the announcing action is performed by generating vibration upon receipt of earthquake motion warning information; if the vibration action is set to be off, then vibration is not generated even if earthquake motion warning information is received.

The sixth setting item permits specifying the locality targeted by announcement. For example, the locality targeted by announcement may be selected from among the localities displayed by the setting portion 61. If the locality set to be targeted by announcement is found included in the localities targeted by earthquake motion warning information (i.e., targeted localities) upon receipt of the earthquake motion warning information, the announcement control portion 63 performs the announcing action in accordance with the other settings.

Not only the locality where the receiving apparatus 1 is located but also other localities may be set to be targeted by announcement. Also, for each of the localities thus set, it is possible to establish the other settings including the one specifying whether to turn on or off the announcing action and the one specifying whether the announcement is to be given by screen display or by audio output.

Furthermore, a plurality of localities may be set to be prioritized. For example, if the localities set to be targeted by earthquake motion warning information include a plurality of localities set to be targeted by announcement, then the announcement control portion 63 performs the announcing action regarding each of the localities in order of their priorities.

As described above, if the locality where the receiving apparatus 1 is located is included in the localities targeted by earthquake motion warning information, the user may have the announcing action carried out in a manner drawing attention to the urgency of the situation by use of a siren sound. If the locality where the receiving apparatus 1 is located is excluded from the localities targeted by earthquake motion warning information, the user may have the announcing action carried out to announce the occurrence of an earthquake using an electronic sound less strident than the siren sound.

The seventh setting item permits specifying the location of the receiving apparatus 1. For example, the location of the receiving apparatus 1 is used to calculate the time it takes for an earthquake motion to arrive at the location. Earthquake motion warning information includes the time of day at which an earthquake occurred and information about the location of the epicenter (latitude, longitude, and depth). Since an earthquake motion propagates at a speed of about 3 to 7 km/s, the time it takes for the earthquake motion to arrive can be predicted approximately by dividing the distance between the epicenter and the location of the receiving apparatus 1 by the speed of earthquake propagation.

The location of the receiving apparatus 1 is set by inputting the address of the location into an input field displayed by the setting portion 61. Alternatively, the location may be selected from a list of localities. As another alternative, the location may be set based on the measurements taken by the GPS sensor 19.

The eighth setting item permits specifying the seismic intensity serving as the reference (i.e., threshold value) by which to determine whether or not to perform the announcing action. This setting is provided where seismic intensity information is included in earthquake motion warning information. In the future, the seismic intensity information may conceivably be included in the earthquake motion warning information transmitted by the AC signal.

If earthquake motion warning information is received and if the seismic intensity represented by information included in the earthquake motion warning information exceeds the threshold seismic intensity, the announcement control portion 63 carries out the announcing action. If the seismic intensity does not exceed the threshold value, then the announcement control portion 63 does not perform the announcing action.

Given the above settings, if the building in which the receiving apparatus 1 is set up is relatively old or if that building has a low capability to resist or absorb tremors, the user may set the threshold seismic intensity low. This makes it possible to have the announcing action carried out even if the earthquake that occurred has a relatively low intensity. If the building in which the receiving apparatus 1 is set up was recently built or if that building has a high capability to resist or absorb tremors, the user may set the threshold seismic intensity high. This makes it possible to leave the announcing action inactive when the earthquake that occurred has a low intensity.

The specifics of the announcing action may be set for each seismic intensity level. For example, the user may set the announcing action to include output of a siren sound where the seismic intensity represented by information included in earthquake motion warning information is intensity level 5, and set the announcing action to provide a screen display where the seismic intensity is level 4.

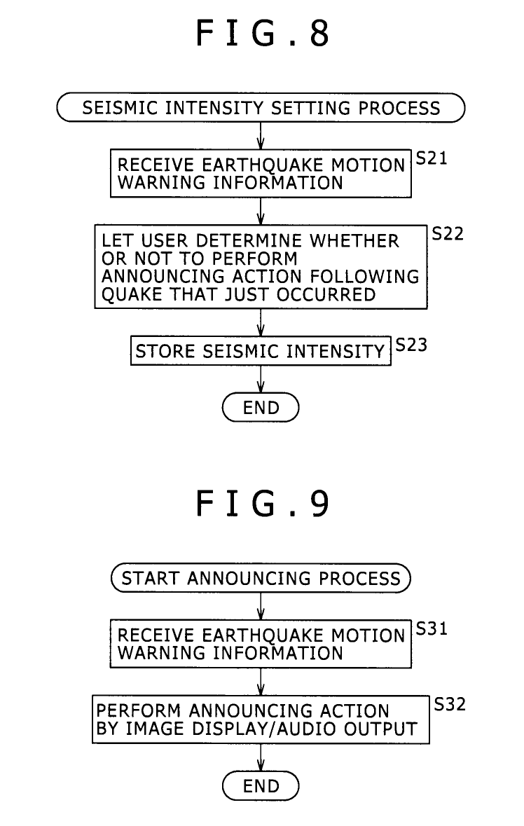

Explained below in reference to the flowchart of FIG. 8 is a process performed by the receiving apparatus 1 to set the seismic intensity as the threshold value by which to determine whether or not to perform the announcing action.

This process is started when earthquake motion warning information is received by the receiving block 12 and stored into the register 12A. That is, the process shown in FIG. 8 is started after an earthquake occurred. It is assumed that the earthquake motion warning information includes seismic intensity information.

In step S21, the earthquake motion warning information receiving portion 62 receives earthquake motion warning information.

In step S22, the setting portion 61 causes the display block 15 to display a message querying whether or not to have an announcing action set to be performed given the earthquake that just occurred. The user may check the message and select whether or not to get the announcing action performed next time a tremor of approximately the same intensity occurs, by operating the remote controller.

If the announcing action is selected to be performed given a tremor of the same intensity as that of the earthquake that just occurred, then step S23 is reached and the setting portion 61 sets the seismic intensity by storing the seismic intensity information included in the earthquake motion warning information. Where the seismic intensity is set in this manner, the intensity may be reset in the same manner as it was initially set. For example, if earthquake motion warning information is received and if the message is displayed querying whether or not to have the announcing action set to be performed given the earthquake that just occurred, the user may choose to set the announcing action inactive. In this case, the selected information is stored and causes the setting portion 61 to reset the current setting (i.e., the setting specifying that the announcing action is to be carried out given the seismic intensity established previously).

Where the above steps have been carried out, the user can establish the settings specifying whether an announcing action is to be performed in reference to an actually experienced tremor.

The seismic intensity measured by the earthquake motion measuring block 20 may be set as the threshold seismic intensity by which to determine whether or not to carry out the announcing action. In this case, the setting portion 61 in step S23 stores information about the seismic intensity measured by the earthquake motion measuring block 20 preparatory to setting the seismic intensity.

Explained below is an example of the announcing action performed in accordance with the above-described settings. The announcing action is carried out when the action was set beforehand to be turned on. [First Example of the Announcing Action]

An announcing action performed by the receiving apparatus 1 is explained below in reference to the flowchart of FIG. 9.

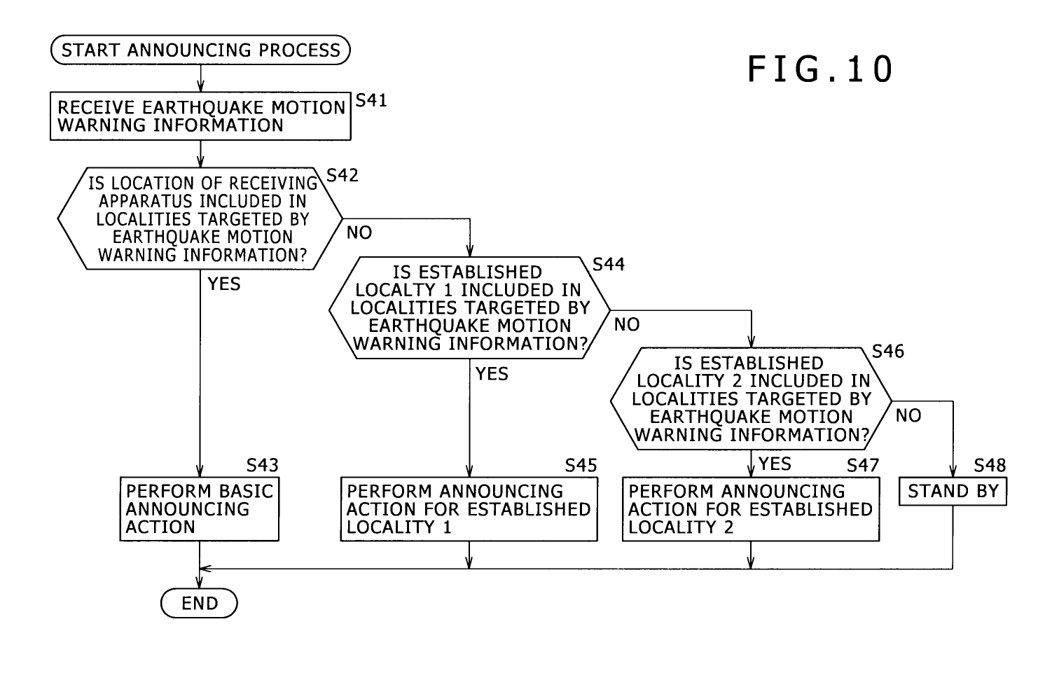

This process is started when earthquake motion warning information is received by the receiving block 12 and stored into the register 12A. Other processes to be explained later in reference to FIGS. 10, 11, 13 and 14 will each be started likewise.

In step S31, the earthquake motion warning information receiving portion 62 receives the earthquake motion warning information.

In step S32, the announcement control portion 63 reads the setting information from the setting portion 61. If earthquake-related information is set to be announced by screen display, the announcement control portion 63 causes the display block 15 to display the information such as the time of day at which the earthquake occurred. If earthquake-related information is set to be announced by audio output, then the announcement control portion 63 causes the speakers 17 to output a voice and a siren sound giving such information as the time of day the earthquake occurred.

If the receiving channel was set beforehand, the set channel starts to be received. The display block 15 displays the image of the TV program being broadcast.

The above steps allow the user to check the earthquake-related information by screen display or by audio output in the manner determined by the user in advance. [Second Example of the Announcing Action]

Explained below in reference to the flowchart of FIG. 10 is another announcing action carried out by the receiving apparatus 1.

With this example of the announcing action, three localities are assumed to be set: the locality where the receiving apparatus 1 is located, and two localities 1 and 2 other than the locality that includes the location of the receiving apparatus 1.

In step S41, the earthquake motion warning information receiving portion 62 receives earthquake motion warning information.

In step S42, the announcement control portion 63 reads the setting information from the setting portion 61, and determines whether the locality where the receiving apparatus 1 is located is included in the localities targeted by the earthquake motion warning information.

If in step S42 the locality that includes the location of the receiving apparatus 1 is found included in the localities targeted by the earthquake motion warning information, then step S43 is reached. In step S43, the announcement control portion 63 performs a basic announcing action. In this case, the basic announcing action signifies an announcing action being carried out in accordance with the settings for the locality where the receiving apparatus 1 is located. As mentioned above, the user is allowed to specify what kind of announcing action is to be performed for each of the localities targeted by the earthquake motion warning information.

On the other hand, if in step S42 the locality that includes the location of the receiving apparatus 1 is not found included in the localities targeted by the earthquake motion warning information, then step S44 is reached. In step S44, the announcement control portion 63 determines whether the set locality 1 is included in the localities targeted by the earthquake motion warning information.

If in step S44 the set locality 1 is found included in the localities targeted by the earthquake motion warning information, then step S45 is reached. In step S45, the announcement control portion 63 performs the announcing action in accordance with the settings for the set locality 1.

If in step S44 the set locality 1 is not found included in the localities targeted by the earthquake motion warning information, then step S46 is reached. In step S46, the announcement control portion 63 determines whether the set locality 2 is included in the localities targeted by the earthquake motion warning information.

If in step S46 the set locality 2 is found included in the localities targeted by the earthquake motion warning information, then step S47 is reached. In step S47, the announcement control portion 63 performs the announcing action in accordance with the settings for the set locality 2.

If in step S46 the set locality 2 is not found included in the localities targeted by the earthquake motion warning information, then step S48 is reached. In step S48, the announcement control portion 63 does not perform any announcing action. If the announcing action is not performed in step S48 or if the announcing action is carried out in any one of steps S43, S45 and S47, the announcing process is terminated.

As described, if an earthquake occurs in a locality other than the one in which the receiving apparatus 1 is located, the user is still able to know the earthquake having taken place. Also, the user can make settings so that the same or a different announcing action may be performed for each of a plurality of localities targeted by the announcement.

The determination in step S42 of whether the locality that includes the location of the receiving apparatus 1 is included in the localities targeted by earthquake motion warning information can be performed on the basis of the measurements taken by the GPS sensor 19. In this case, it is determined in step S42 whether the position measured by the GPS sensor 19 is included in the localities targeted by the earthquake motion warning information. If the measured position is determined to be included in the localities in question, then the basic announcing action is performed in step S43. [Third Example of the Announcing Action]

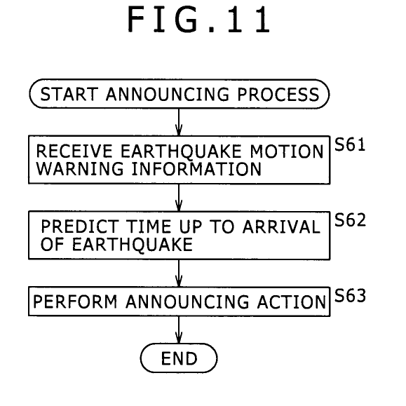

Explained below in reference to the flowchart of FIG. 11 is another announcing action carried out by the receiving apparatus 1.

In step S61, the earthquake motion warning information receiving portion 62 receives earthquake motion warning information.

In step S62, the announcement control portion 63 reads the setting information from the setting portion 61 and, based on the location of the receiving apparatus 1 and on the epicenter location represented by information included in the earthquake motion warning information, predicts the time it will take for the earthquake to arrive.

In step S63, the announcement control portion 63 controls the announcing action in accordance with the predicted time up to the arrival of the earthquake.

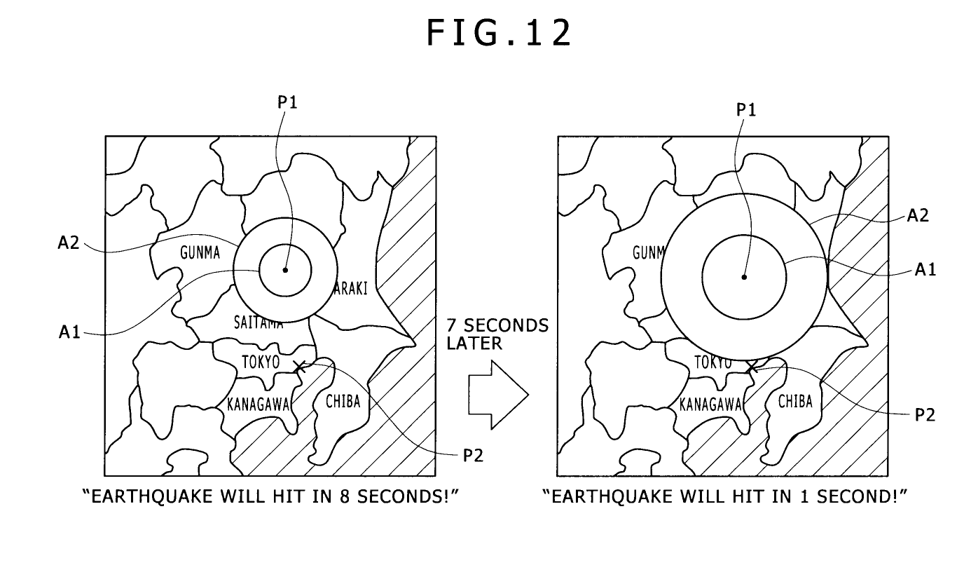

FIG. 12 is a schematic view showing typical images that vary with the time it takes for an earthquake to arrive.

The maps shown in FIG. 12 are displayed on the display block 15 on the basis of the image data prepared beforehand in the receiving apparatus 1. A position P1 on the left-hand side map in FIG. 12 represents the epicenter location specified by information included in the earthquake motion warning information. A position P2 denotes the location of the receiving apparatus 1 specified by the setting information.

A circuit A1 indicates the range reached by S (secondary) waves (i.e., major tremors). The range of the circle Al is determined by three factors: by a propagation speed of about 3 km/s of the S waves; by the time of day at which the earthquake occurred and indicated by information included in the earthquake motion warning information; and by the current time of day managed by the receiving apparatus 1. Starting from the position P1 (i.e., epicenter) taken as the center, the circle Al is drawn on the map with a radius given by the distance obtained by multiplying the time interval between the time at which the earthquake occurred and the current time by the propagation speed of about 3 km/s.

A circuit A2 indicates the range reached by P (primary) waves (i.e., initial tremors). The range of the circle A2 is also determined by three factors: by a propagation speed of about 7 km/s of the P waves; by the time of day at which the earthquake occurred and indicated by information included in the earthquake motion warning information; and by the current time of day managed by the receiving apparatus 1. Starting from the position P1 (i.e., epicenter) taken as the center, the circle A2 is drawn on the map with a radius given by the distance obtained by multiplying the time interval between the time at which the earthquake occurred and the current time by the propagation speed of about 7 km/s.

The announcement control portion 63 informs the user of the time it will take for the earthquake to arrive, by displaying the map such as one shown on the left in FIG. 12. The sizes of the circles A1 and A2 are shown to grow as time elapses. By watching the circles A1 and A2 grow in size over time, the user can visually check the time it will take for the earthquake to arrive.

Also, when displaying the left-hand side map in FIG. 12, the announcement control portion 63 causes the speakers 17 to output a voice announcing the time it will take for the earthquake to arrive, such as “Earthquake will hit in eight seconds.”

The right-hand side image in FIG. 12 is a map given seven seconds after the time at which the left-hand side map was displayed. The right-hand side map in FIG. 12 shows the circles A1 and A2 becoming larger than the corresponding circles in the left-hand side map. By viewing the right-hand side map in FIG. 12, the user can verify that the earthquake is about to arrive.

When displaying the right-hand side map in FIG. 12, the announcement control portion 63 causes the speakers 17 to output a voice announcing the time it will take for the earthquake to arrive, such as “Earthquake will hit in one second.”

Alternatively, the time up to the predicted arrival of the earthquake may be displayed or audibly output in countdown fashion. [Fourth Example of the Announcing Action]

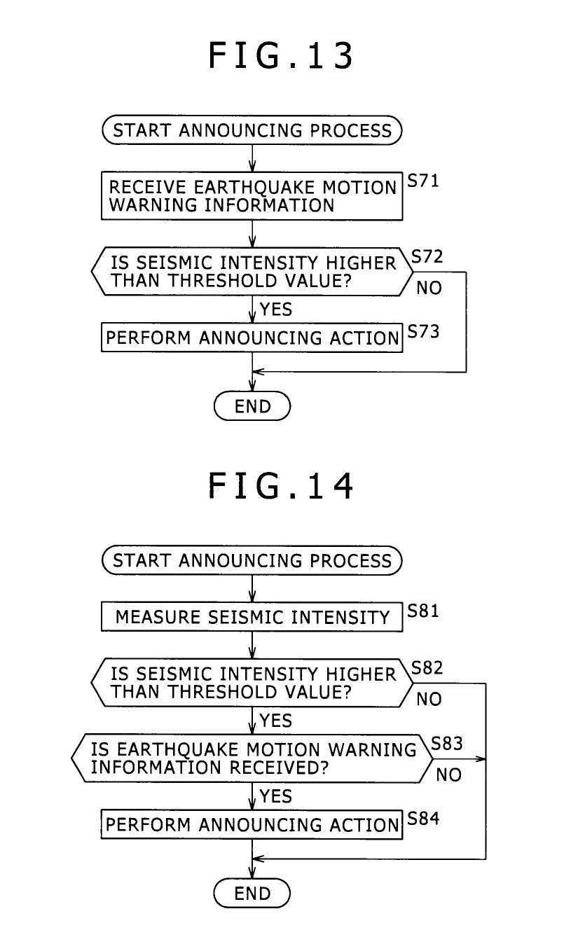

Explained below in reference to the flowchart of FIG. 13 is another announcing action carried out by the receiving apparatus 1. This process is performed when seismic intensity information is included in earthquake motion warning information.

In step S71, the earthquake motion warning information receiving portion 62 receives the earthquake motion warning information.

In step S72, the announcement control portion 63 reads the setting information from the setting portion 61, and determines whether the seismic intensity represented by information included in the earthquake motion warning information exceeds a seismic intensity level established as the threshold value by which to determine whether or not to perform an announcing action.

If in step S72 the seismic intensity represented by information included in the earthquake motion warning information is found to exceed the threshold seismic intensity, then step S73 is reached. In step S73, the announcement control portion 63 performs the announcing action. If the content of the announcing action is set for each of different seismic intensity levels, then the announcing action is carried out here in accordance with the content of the seismic intensity represented by information in the earthquake motion warning information.

If the announcing action is performed in step S73, or if in step S72 the seismic intensity represented by information included in the earthquake motion warning information is not found to exceed the threshold seismic intensity, then the announcing process is terminated.

In the manner described above, the user is able to have the announcing action carried out solely when it is deemed urgent to announce the earthquake in view of the situation of the building where the receiving apparatus 1 is installed and of the status of the tremors in question. [Fifth Example of the Announcing Action]

Explained below in reference to the flowchart of FIG. 14 is another announcing action carried out by the receiving apparatus 1.

In step S81, the earthquake motion measuring block 20 measures seismic intensity.

In step S82, the announcement control portion 63 reads the setting information from the setting portion 61, and determines whether the seismic intensity measured by the earthquake motion measuring block 20 exceeds the seismic intensity established as the threshold value by which to determine whether or not to perform an announcing action.

If in step S82 the seismic intensity measured by the earthquake motion measuring block 20 is found to exceed the threshold seismic intensity, then step S83 is reached. In step S83, the announcement control portion 63 determines whether earthquake motion warning information is received by the earthquake motion warning information receiving portion 62. For example, if the earthquake motion warning information is received between the time a seismic intensity level higher than the threshold value is measured by the earthquake motion measuring block 20 and the time a predetermined time period has elapsed, then it is determined that the earthquake motion warning information has been received by the earthquake motion warning information receiving portion 62.

If it is determined in step S83 that the earthquake motion warning information has been received by the earthquake motion warning information receiving portion 62, then step S84 is reached and the announcement control portion 63 performs the announcing action.

If the announcing action is performed in step S84, if in step S82 the seismic intensity measured by the earthquake motion measuring block 20 is not found to exceed the threshold seismic intensity, or if in step S83 the earthquake motion warning information is not found received, then the announcing process is determined.

The tremors measured by the earthquake motion measuring block 20 may have been generated not by an earthquake but by the building in which the receiving apparatus 1 is set up. Where the building is located along an arterial highway or railroad tracks, tremors other than those of an earthquake may sometimes be measured by the earthquake motion measuring block 20.

As described, the announcing action may be carried out if tremors are detected by the earthquake motion sensor installed inside or outside the receiving apparatus 1 and if earthquake motion warning information is transmitted by broadcast waves at the same time. This arrangement makes it possible to reduce false alarms compared with the case in which the announcing action is performed upon determination that an earthquake has occurred solely on the basis of the output from the earthquake motion sensor.

[Variations]

The diverse settings discussed above may be used in combinations. For example, it is possible to set for each of a plurality of localities a seismic intensity level serving as the threshold value by which to determine whether or not to perform an announcing action. It is also possible to change the content of the announcing action for each of the different seismic intensity levels established.

In the foregoing description, the earthquake motion warning information was shown transmitted using the AC signal. Alternatively, the announcing action may be set in like manner when warning information other than the earthquake motion warning information is transmitted. Such warning information may include information about meteorological conditions including typhoons and information regarding tsunamis.

[Examples in Which the Invention is Applied to a Receiving System]

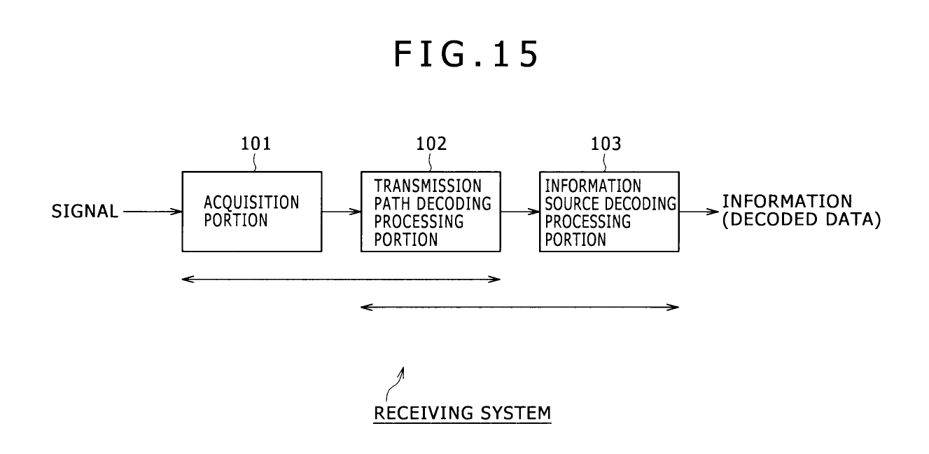

FIG. 15 is a block diagram showing a typical configuration of a receiving system to which the receiving block 12 of the present invention is applied in order to constitute a first embodiment of the invention.

The receiving system in FIG. 15 is made up of an acquisition portion 101, a transmission path decoding processing portion 102, and an information source decoding processing portion 103.

The acquisition portion 101 acquires signals through transmission paths such as terrestrial digital broadcasts, satellite digital broadcasts, CATV networks, the Internet, and other networks, not shown. The acquired signals are forwarded from the acquisition portion 101 to the transmission path decoding processing portion 102. The receiving block 12 shown in FIG. 3 may be included in the acquisition portion 101 for example.

The transmission path decoding processing portion 102 performs transmission path decoding processes including error correction on the signals acquired by the acquisition portion 101 via transmission paths. The resulting signals from the decoding processing are supplied to the information source decoding processing portion 103.

The information source decoding processing portion 103 performs information source decoding processes on the signals having undergone the transmission path decoding processing, the information source decoding processes including one in which compressed information is expanded to the original information for acquisition of the transmitted data.

That is, the signals acquired by the acquisition portion 101 via transmission paths may have undergone compression encoding whereby information was compressed to reduce the sizes of video and audio data. In that case, the information source decoding processing portion 103 performs information source decoding processes such as one in which the compressed information is expanded to the original information.

If the signals acquired by the acquisition portion 101 via transmission paths have not undergone compression encoding, then the information source decoding processing portion 103 does not perform any information expanding process. A typical expanding process may be MPEG decoding. It should be noted that the information source decoding processes may include a descramble process and the like besides the expanding process.

The receiving system in FIG. 15 may be applied, for example, to TV tuners for receiving digital TV broadcasts. The acquisition portion 101, transmission path decoding processing portion 102, and information source decoding processing portion 103 may each be implemented in the form of an independent device (hardware (IC (integrated circuit)) or a software module).

Alternatively, the acquisition portion 101, transmission path decoding processing portion 102, and information source decoding processing portion 103 may be implemented altogether as an independent device. As another alternative, the acquisition portion 101 and transmission path decoding processing portion 102 may be implemented in combination as an independent device. As a further alternative, the transmission path decoding processing portion 102 and information source decoding processing portion 103 may be implemented in combination as an independent device.

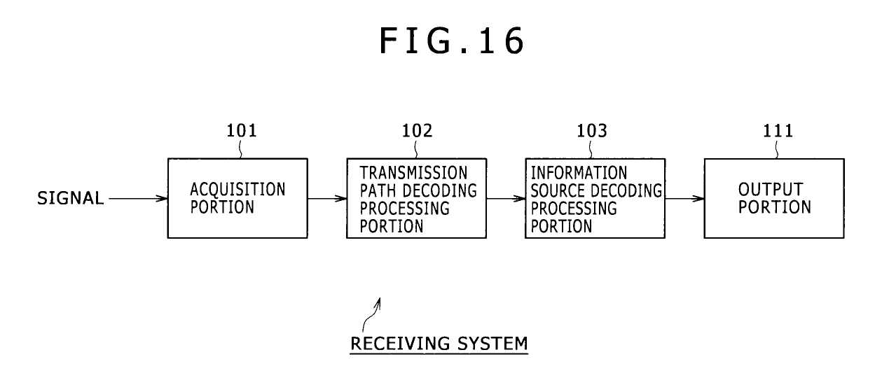

FIG. 16 is a block diagram showing a typical configuration of the receiving system to which the receiving block 12 of the present invention is applied in order to constitute a second embodiment of the invention.

In FIG. 16, the components that have their functionally equivalent counterparts included in FIG. 15 are designated by the same reference numerals, and their descriptions are omitted hereunder where redundant.

The configuration of the receiving system in FIG. 16 is the same as that which is shown in FIG. 15 in that the acquisition portion 101, transmission path decoding processing portion 102, and information source decoding processing portion 103 are all provided. What makes the configuration of FIG. 16 different from that of FIG. 15 is that an output portion 111 is newly provided.

For example, the output portion 111 may be a display device that displays images and/or speakers that output sounds. As such, the output portion 111 outputs images and sounds represented by the signals output from the information source decoding processing portion 103. That is, the output portion 111 serves to display images and/or to output sounds.

The receiving system in FIG. 16 may be applied, for example, to TV sets for receiving digital TV broadcasts or to radio receivers for receiving radio broadcasts.

If the signals acquired by the acquisition portion 101 have not undergone compression encoding, the signals output by the transmission path decoding processing portion 102 are sent directly to the output portion 111.

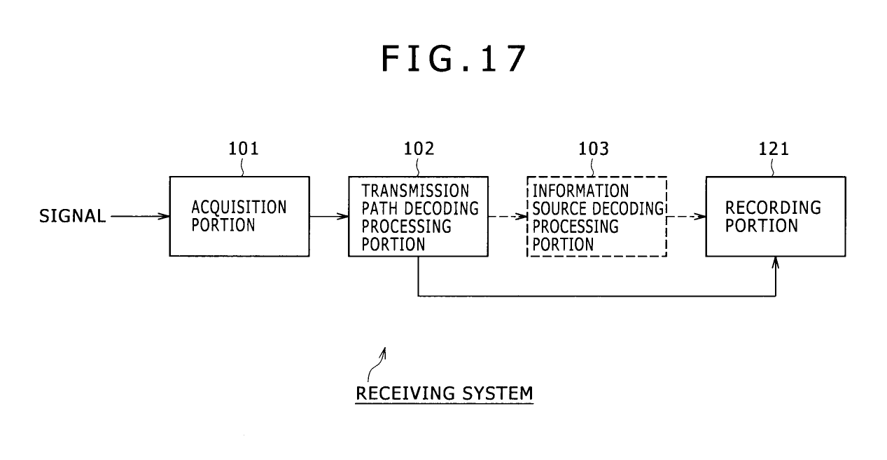

FIG. 17 is a block diagram showing a typical configuration of the receiving system to which the receiving block 12 of the present invention is applied in order to constitute a third embodiment of the invention.

In FIG. 17, the components that have their functionally equivalent counterparts included in FIG. 15 are designated by the same reference numerals, and their descriptions are omitted hereunder where redundant.

The configuration of the receiving system in FIG. 17 is the same as that which is shown in FIG. 15 in that the acquisition portion 101 and transmission path decoding processing portion 102 are both provided. What makes the configuration of FIG. 17 different from that of FIG. 15 is that the information source decoding processing portion 103 is not included and that a recording portion 121 is newly provided.

The recording portion 121 records the signals output from the transmission path decoding processing portion 102 (e.g., MPEG transport stream packets) to recording (storage) media such as optical disks, a hard disk (magnetic disk), and a flash memory.

The above-described receiving system in FIG. 17 may be applied, for example, to recorders for receiving TV broadcasts.

Alternatively, the information source decoding processing portion 103 may be included so that the signals having undergone the information source decoding processing by the information source decoding processing portion 103, i.e., images and sounds acquired through decoding, may be recorded to the recording portion 121.

[Structure of the Computer]

The series of the steps and processes described above may be executed either by hardware or by software. Where the software-based processing is to be carried out, the programs constituting the software may be either incorporated beforehand in the dedicated hardware of the computer to be used or installed upon use from a suitable program storage medium into a general-purpose personal computer or like equipment capable of executing diverse functions based on the installed programs.

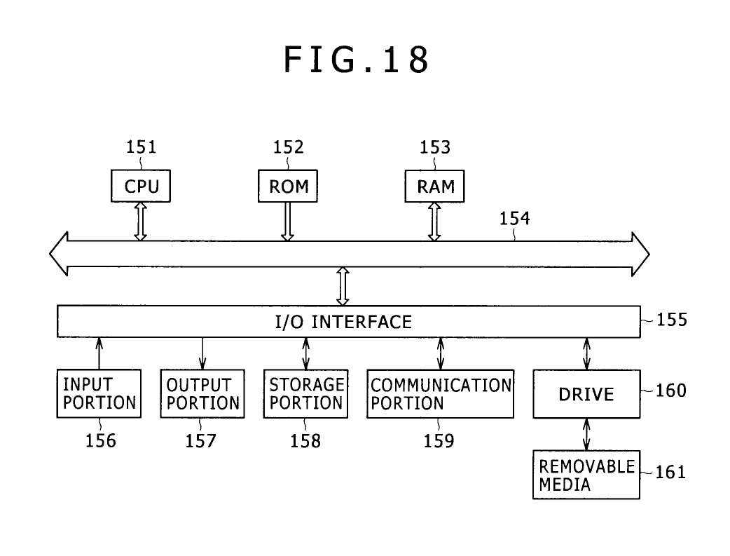

FIG. 18 is a block diagram showing a typical hardware structure of a computer for carrying out the series of the above-described steps and processes using programs.

A CPU (central processing unit) 151, a ROM (read only memory) 152, and a RAM (random access memory) 153 are interconnected via a bus 154.

An input/output interface 155 is also connected to the bus 154. The input/output interface 155 is connected with an input portion 156 typically made of a keyboard and a mouse, and with an output portion 157 generally formed by a display and speakers. The input/output interface 155 is further connected with a storage portion 158 usually composed of a hard disk or a nonvolatile memory, with a communication portion 159 typically constituted by a network interface, and with a drive 160 for driving removable media 161.

In the computer structured as outlined above, the CPU 151 loads relevant programs from, say, the storage portion 158 through the input/output interface 155 and bus 154 into the RAM 153 for program execution, whereby the series of the above-described steps and processes is carried out.

For example, the programs executed by the CPU 151 may be offered recorded on the removable media 161 or transmitted via wired or wireless transmission media such as local area networks, the Internet, and digital broadcasts, before being installed into the storage portion 158.

Also, the programs for execution by the computer may be processed in the depicted sequence of this specification (i.e., on a time series basis), in parallel, or in otherwise appropriately timed fashion such as when they are invoked.

The present application contains subject matter related to that disclosed in Japanese Priority Patent Application JP 2010-110418 filed in the Japan Patent Office on May 12, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A receiving apparatus comprising:
receiving means for receiving warning information;
setting means for establishing settings regarding an announcing action to be performed upon receipt of said warning information, in accordance with operations performed by a user; and
control means for controlling, upon receipt of said warning information, said announcing action in accordance with the settings established by said setting means.

2. The receiving apparatus according to claim 1, wherein said setting means establishes whether or not to perform said announcing action.

3. The receiving apparatus according to claim 1, wherein said setting means establishes at least one of two settings, one of said two settings specifying that the content of a warning is to be announced by screen display, the other setting specifying that the content of the warning is to be announced by audio output.

4. The receiving apparatus according to claim 3, wherein
said setting means establishes a receiving channel from among the channels on which programs are being broadcast; and
upon receipt of said warning information where the setting is established specifying that the content of said warning is to be announced by screen display, said control means displays information indicative of the content of said warning on a screen together with an image of the program being broadcast on said receiving channel.

5. The receiving apparatus according to claim 3, wherein
said setting means establishes a receiving channel from among the channels on which programs are being broadcast; and
upon receipt of said warning information where the setting is established specifying that the content of said warning is to be announced by audio output, said control means provides an audio output indicative of the content of said warning together with an image of the program being broadcast on said receiving channel and displayed on a screen.

6. The receiving apparatus according to claim 1, further comprising
generating means for generating vibration,
wherein said setting means establishes whether or not to perform said announcing action so as to announce the occurrence of an earthquake using the vibration generated by said generating means.

7. The receiving apparatus according to claim 1, wherein
said setting means establishes a locality; and
if said warning information is received and if the localities included in said warning information and represented by targeted locality information indicative of the localities targeted by the warning include the locality established by said setting means, then said control means performs said announcing action in accordance with the settings established by said setting means.

8. The receiving apparatus according to claim 7, wherein
said setting means establishes a plurality of localities and establishes the settings regarding said announcing action for each of said plurality of localities; and
said control means performs said announcing action in accordance with the settings established for each of said plurality of localities.

9. The receiving apparatus according to claim 1, wherein said warning information is earthquake motion warning information.

10. The receiving apparatus according to claim 9, wherein
said setting means establishes the location of said receiving apparatus; and
if said warning information constituting said earthquake motion warning information is received, then said control means, based on the location of an epicenter represented by information included in said warning information, calculates the time for an earthquake motion to reach the location established by said setting means and controls said announcing action in accordance with the calculated time.

11. The receiving apparatus according to claim 9, further comprising
measuring means for measuring a current location,
wherein, if said warning information constituting said earthquake motion warning information is received, then said control means, based on the location of an epicenter represented by information included in said warning information, calculates the time for an earthquake motion to reach the location measured by said measuring means and controls said announcing action in accordance with the calculated time.

12. The receiving apparatus according to claim 9, wherein
said setting means establishes a seismic intensity serving as a reference by which to determine whether or not to perform said announcing action; and
if said warning information constituting said earthquake motion warning information is received and if the seismic intensity represented by information included in said warning information exceeds the seismic intensity established by said setting means, then said control means performs said announcing action.

13. The receiving apparatus according to claim 12, wherein, if said warning information is received and if said user, prompted to select whether or not to establish a seismic intensity, selects establishment of the seismic intensity, then said setting means establishes the seismic intensity represented by the information included in said warning information as the seismic intensity serving as the reference by which to determine whether or not to perform said announcing action.

14. The receiving apparatus according to claim 9, further comprising
measuring means for measuring a seismic intensity, wherein
said setting means establishes a seismic intensity serving as a reference by which to determine whether or not to perform said announcing action; and
if the seismic intensity measured by said measuring means exceeds the seismic intensity established by said setting means, then said control means performs said announcing action.

15. The receiving apparatus according to claim 14, wherein, if said warning information constituting said earthquake motion warning information is received and if the seismic intensity measured by said measuring means exceeds the seismic intensity established by said setting means, then said control means performs said announcing action.

16. The receiving apparatus according to claim 9, further comprising
signal receiving means for receiving a signal output from a measuring device measuring a seismic intensity, wherein
said setting means establishes a seismic intensity serving as a reference by which to determine whether or not to perform said announcing action; and
if the seismic intensity represented by the signal received by said signal receiving means exceeds the seismic intensity established by said setting means, then said control means performs said announcing action.

17. An announcement control method comprising the steps of:
receiving warning information;
establishing settings regarding an announcing action to be performed upon receipt of said warning information, in accordance with operations performed by a user; and
controlling, upon receipt of said warning information, said announcing action in accordance with said settings.

18. A program for causing a computer to execute a procedure comprising the steps of:
receiving warning information;
establishing settings regarding an announcing action to be performed upon receipt of said warning information, in accordance with operations performed by a user; and
controlling, upon receipt of said warning information, said announcing action in accordance with said settings.

19. A receiving apparatus comprising:
a receiving portion configured to receive warning information;
a setting portion configured to establish settings regarding an announcing action to be performed upon receipt of said warning information, in accordance with operations performed by a user; and
a control portion configured to control, upon receipt of said warning information, said announcing action in accordance with the settings established by said setting portion.
